(19) United States
(12) Patent Application Publication
(10) Pub. No.: US 2021/0349748 A1
(43) Pub. Date: Nov. 11, 2021

(54) VIRTUAL MACHINE RESTORATION FOR ANOMALY CONDITION EVALUATION

(71) Applicant: Hewlett Packard Enterprise Development LP, Houston, TX (US)

(72) Inventors: Alexander Dunfey, Westborough, MA (US); Vinay Jonnakuti, Bangalore Karnataka (IN)

(21) Appl. No.: 16/871,568

(22) Filed: May 11, 2020

(51) Int. Cl. G06F 9/455; H04L 29/06; G06F 21/53; G06F 21/56; G06F 3/06

(52) U.S. Cl. CPC G06F 9/45558; H04L 63/0272; G06F 21/53; G06F 21/568; G06F 3/0619; G06F 2221/033; G06F 3/0664; G06F 3/0673; G06F 2009/45562; G06F 2009/45587; G06F 3/065

(57) ABSTRACT

Architectures and mechanisms for anomaly recovery are disclosed. A virtual machine point-in-time copy having an isolated network connection is generated in response to an anomaly condition in an original virtual machine. The virtual machine copy is a point-in-time copy of the parent virtual machine. A first point-in-time backup copy is restored to the virtual machine copy utilizing the isolated network connection to generate a first restored virtual machine. The first restored virtual machine is evaluated for the anomaly condition. The original virtual machine is replaced with the first restored virtual machine if the anomaly condition does not exist in the first restored virtual machine. A second point-in-time backup copy is restored to the virtual machine copy utilizing the isolated network connection to generate a second restored virtual machine if the anomaly condition exists in the first restored virtual machine.

### BACKGROUND

Generically, malware is software intentionally designed to cause damage to a computer, server, client, or computer network. Malware can include, for example, electronic viruses, worms, Trojan horses, ransomware, spyware, adware, etc. More specifically, an electronic virus is a type of program that, when executed, replicates itself by modifying other programs and inserting its own code. When this occurs, the host electronic system is “infected” with the virus. Electronic viruses cause billions of dollars of economic damage each year by causing system failure, wasting computer resources, corrupting data, increasing maintenance costs, stealing personal information, etc. Ransomware is a type of malware that threatens to publish the victim's data or perpetually block access to the data unless a ransom is paid. While some simple ransomware may lock a system in a way which is not difficult for a knowledgeable person to reverse, more advanced malware uses a technique called cryptoviral extortion, in which it encrypts the victim's files, making them inaccessible, and demands a ransom payment to decrypt them. Thus, protection from, and recovery from, these threats is important for a broad range of devices users from individuals to large organizations.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is one embodiment of an environment having multiple virtual machines that can provide automated anomaly recovery.

FIG. 2 is a flow diagram of one embodiment of a technique to provide automated anomaly recovery in an environment having multiple virtual machines.

FIG. 3 is a block diagram of one embodiment of a processing resource and a machine readable medium encoded with example instructions to provide automated anomaly recovery.

FIG. 4 is a block diagram of one embodiment of a hyper-converged architecture that can provide automated anomaly recovery in an environment having multiple virtual machines.

FIG. 5 is a block diagram of one embodiment of a hyper-converged architecture that can provide parallel automated anomaly recovery in an environment having multiple virtual machines.

### DETAILED DESCRIPTION

In the following description, numerous specific details are set forth. However, embodiments of the invention may be practiced without these specific details. In other instances, well-known structures and techniques have not been shown in detail in order not to obscure the understanding of this description.

When a virtual machine (VM) is infected by a virus, ransomware or some other anomaly that results in an unrecoverable loss of data, the user of the VM will want to recover as much data as possible as quickly as possible. In an environment providing point-in-time data backups (local, remote or both) a user of the VM may be able to recover some or all of the lost data from the backups, but the user might not know when the anomaly occurred and thus may not know which backup to use. Manually determining this recovery point can be a time-consuming, error-prone process.

Described herein are techniques and mechanisms for an automated recovery system that detect whether a point-in-time copy of a virtual machine has been impacted by an anomaly. Further, in various embodiments, these techniques and mechanisms can automatically, rapidly and safely find and restore the most recent copy of the VM that is not infected by the ransomware, virus, anomaly causing data loss, etc.

In various embodiments, the automated recovery mechanisms are not required to have anomaly detection capability. External anomaly detection functionality can be triggered or initiated with a resulting status to indicate whether the restored VM is infected. In one embodiment, a hypervisor application programming interface (API) can be used by the automated recovery mechanisms to copy and/or execute anomaly detection functionality as needed to a running, restored VM. In one embodiment, this can be accomplished utilizing sandboxing techniques and/or virtual private network (VPN) connections.

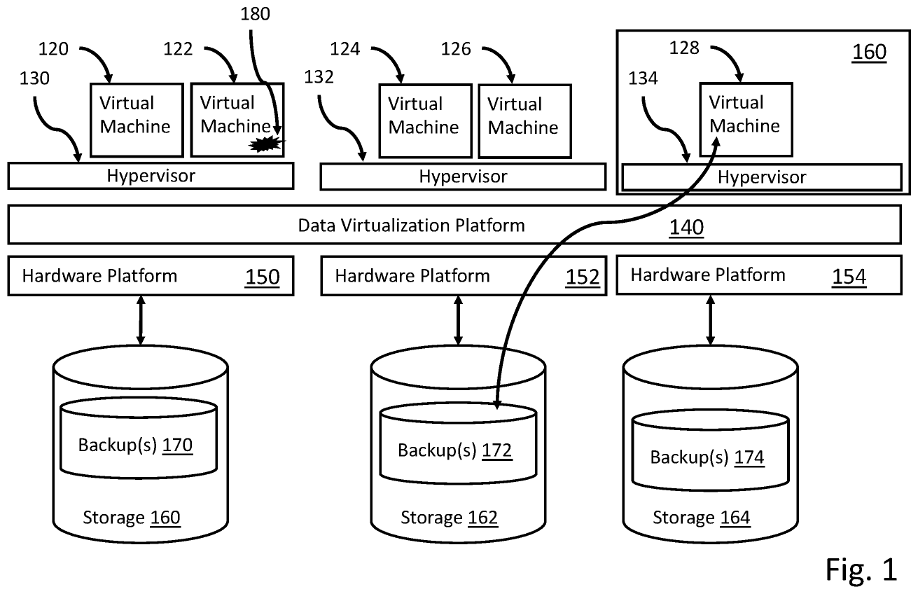

FIG. 1 is one embodiment of an environment having multiple virtual machines that can provide automated anomaly recovery. The example architecture of FIG. 1 is just one sample architecture type that can provide the automated anomaly recovery mechanisms described herein.

In the example architecture of FIG. 1, data virtualization platform 140 can function to provide an interface between any number of hardware platforms (e.g., 150, 152, 154) and any number of virtual machines (e.g., 120, 122, 124, 126, 128) utilizing any number of hypervisors (e.g., 130, 132, 134).

Virtual machines (e.g., 120, 122, 124, 126, 128) are emulations of hardware computer systems and can provide the functionality of a physical computer. The hardware running the virtual machine is referred to as the host and the virtual machine(s) are referred to as the guest(s). Hypervisors (e.g., 130, 132, 134), which can also be referred to as virtual machine monitors (VMMs), function to create and run the virtual machines. The hypervisors run on the host machines and manage the execution of the one or more virtual operating systems.

Each platform can have associated storage structures (e.g., 160, 162, 164) that can be utilized to store point-in-time backups (e.g., 170, 172, 174). In some embodiments, storage devices can be deduplicated and/or compressed. In various embodiments, backups can be distributed across storage devices.

Hardware platforms (e.g., 150, 152, 154) function as the host machines. The hardware platforms can include storage devices (e.g., 160, 162, 164), which can be any type and/or combination of storage devices. One or more of the storage devices can be utilized to manage backups for one or more of the virtual machines. Various mechanisms for management of data storage and backups will be described in greater detail below.

If, for example, VM 122 experiences an anomaly (e.g., 180), a copy VM (e.g., 128) can be created in a sandbox environment (e.g., 160). A backup from a previous point in time for the parent VM (e.g., VM 122) can be restored to copy VM 128 in sandbox environment 160. A point-in-time backup may also be known as a snapshot in some implementations. In some embodiments, this can be done via secure connection, for example, via VPN. As described in greater detail below, a process of automatic restoration of backups and anomaly detection of the restored state can be iterated through until the most recent non-infected backup is restored. In some embodiments, multiple sandbox environments with corresponding backup restorations can be utilized.

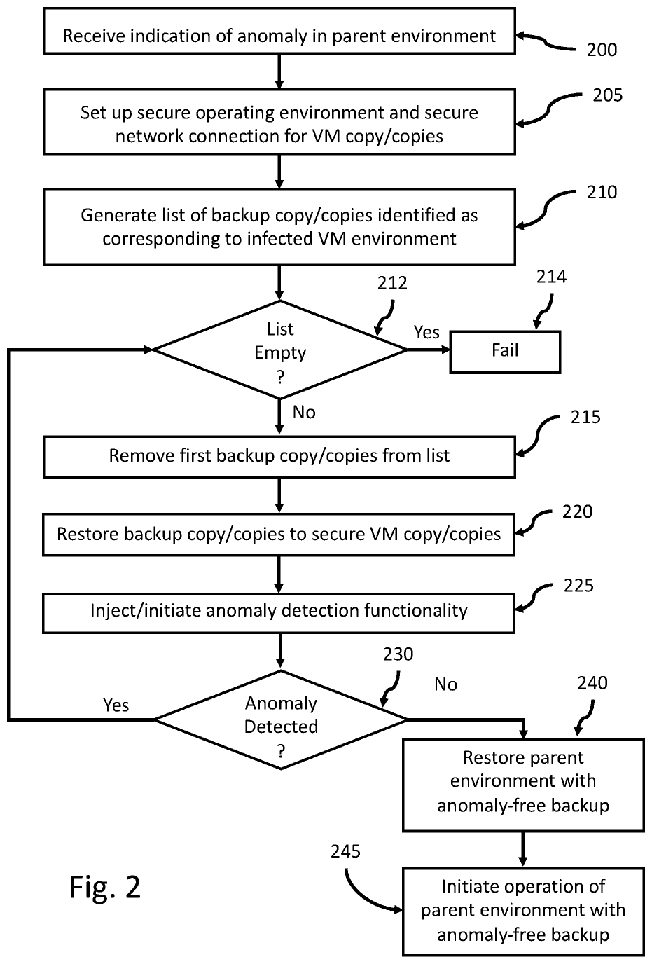

FIG. 2 is a flow diagram of one embodiment of a technique to provide automated anomaly recovery in an environment having multiple virtual machines. The technique of FIG. 2 can be utilized, for example, in an environment like that of FIG. 1. Other operating environments can also be utilized.

An indication of an anomaly in a parent operating environment can be received, 200. The anomaly can be any type of malware including, for example, an electronic virus or ransomware. Any mechanism can be utilized for detection of the anomaly including, for example, malware detection software, external notification, etc.

In response to the detected anomaly, a secure operating environment having a secure connection can be set up, 205. In one embodiment, a virtual machine (VM) is set up in a secure sandbox environment having an isolated virtual private network (VPN) connection to receive backup data. Use of an isolated VPN connection allows the VM to be powered on without potentially causing damage to other devices (e.g., other computers on the same network, connected mobile devices). In one embodiment, the VM that is set up in the secure environment is a copy of the infected VM. In some embodiments only a single VM copy is utilized for automated recovery operations. In other embodiments, multiple VM copies are utilized for automated recovery operations.

A list of one or more point-in-time backup copies identified as corresponding to the infected VM is generated, 210. In complex computing environments, having multiple VMs and consistent periodic backup operations can result in a large number of backup copies across multiple storage devices. In some embodiments, the recovery process starts with identifying the most recent backup from the infected VM. In alternate embodiments, some offset from the most recent backup can be utilized. In some embodiments, a binary search can be utilized to determine which backup introduced the anomaly. For example, a bisection technique can be utilized to identify a change set that corresponds to a change in behavior (e.g., introduction of an anomaly).

If the list is empty, 212, the process fails, 214. If the list is not empty, 212, the first backup copy/copies is/are removed from the list, 215. In complex embodiments, multiple backups can be identified and processed in parallel. For example, in an embodiment utilizing three secure, isolated VMs, the three most recent backups can be identified to be utilized in parallel. In alternate embodiments other configurations can also be supported. The identified backup copy/copies are restored to the VM copies via secure channels, 220.

Once the backup copy/copies are restored to the secure VM environment(s), anomaly detection can be performed on the restored VM(s). In various embodiments, this can be accomplished by injecting anomaly detection functionality to the restored VM, or by initiating anomaly detection functionality that may already exist within the VM, 225.

If an anomaly is detected, 230, the list is checked, 212, to determine whether the list is empty of if additional backups are available. That is, the backup copies are to be restored and evaluated in reverse chronological order so that the most recent non-infected backup can be utilized. In some embodiments, this process can be automated and function in the background so that a user experiences minimal disruption or may even be unaware of the anomaly. In some embodiments, backups can be proactively reviewed to detect anomalies.

In some embodiments iteration through the backup copies can be performed sequentially, for example, in reverse chronological order. In other embodiments, reviewing/iterating through backup copies can be performed with some level of parallelism, for example, X backups processes in parallel and moving through the set of available backups in approximately reverse chronological order. As another alternative, non-linear approaches can be utilized, for example, a binary search technique can be utilized.

If no anomaly is detected in a VM, 230, the parent (originally infected) environment is restored using backup that has been analyzed and has been determined to be anomaly-free, 240. Thus, in embodiments in which the backups are restored and analyzed in reverse chronological order the data restored to the parent environment will be the most recent non-infected version. The parent environment can then operate using the newly-restored anomaly-free data, 245.

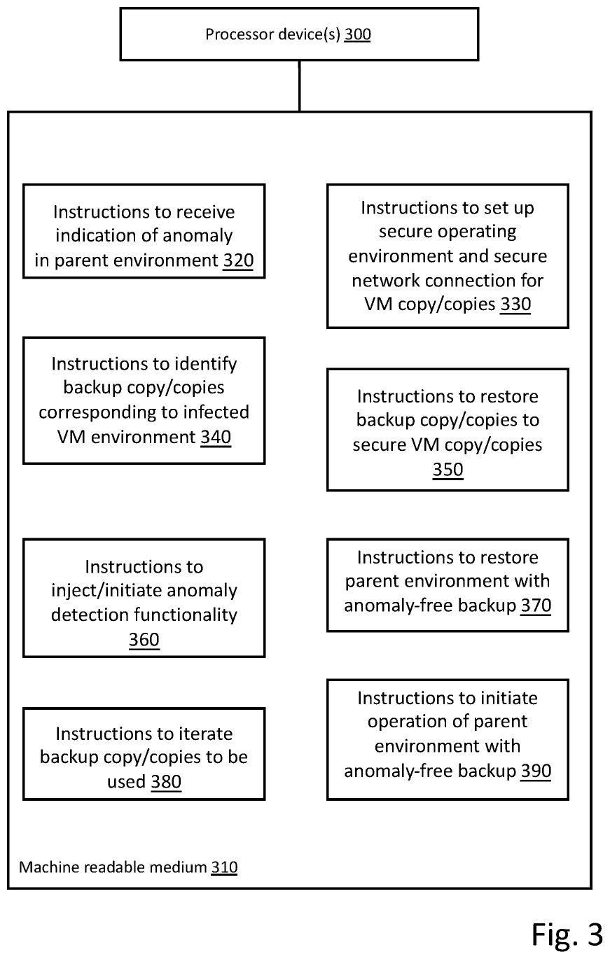

FIG. 3 is a block diagram of one embodiment of a processing resource and a machine readable medium encoded with example instructions to provide automated anomaly recovery. Machine readable medium 310 is non-transitory and is alternatively referred to as a non-transitory machine readable medium 310. In some examples, the machine readable medium 310 may be accessed by processor device(s) 300. Processor device(s) 300 and machine readable medium 310 may be included, for example, in hardware platforms, such as platforms 150, 152 and 154 of FIG. 1.

Machine readable medium 310 may be encoded with example instructions 320, 330, 340, 350, 360, 370, 380 and 390. Instructions 320, 330, 340, 350, 360, 370, 380 and 390, when executed by the processor device(s) 300, may implement various aspects of techniques to provide automated anomaly recovery as described herein.

Instructions 320 can cause processor device(s) 300 to receive or detect an indication of an anomaly in the parent VM environment. Instructions 330 can cause processor device(s) to set up a secure environment (e.g., sandbox with isolated VPN) with a copy of the parent VM in response to the indication of an anomaly condition.

Instructions 340 can cause processor device(s) 300 to identify backup copies corresponding to the parent VM environment. Instructions 350 can cause processor device(s) 300 to restore one or more of the identified backup copies to the VM(s) in the secure environment(s). As discussed above, this can be done sequentially or multiple VMs can operate in parallel secure environments.

Instructions 360 can cause processor device(s) 300 to inject anomaly detection functionality to the secure VM operating environments and/or initiate anomaly detection functionality within the secure VM operating environment(s). Instructions 370 can cause processor device(s) 300 to restore the anomaly-free version (when found) to the parent VM operating environment to replace the infected version.

Instructions 380 can cause processor device(s) 300 to iterate the backup copy/copies to be restored to the secure VM operating environments in response to a previous version not being anomaly-free. Instructions 390 can cause processor device(s) 300 to initiate operation of the parent VM environment after restoration to the anomaly-free state.

The functionality and mechanisms described herein can be particularly efficient when utilized in a compressed and deduplicated backup environment that can both backup and restore data in a manner that is both space-efficient and time-efficient, such as certain hyper-converged and/or storage virtualization infrastructure. While compression is not required, it can be utilized to provide system benefits. By leveraging rapid restore and deduplication capabilities of such an environment, the automated mechanisms described herein can do iterations of the described techniques on multiple backup copies in parallel without impacting the storage capacity of the underlying system and finding the most recent safe backup copy far more rapidly than a manual procedure.

For example, a storage virtualization infrastructure may store data as individual objects in a deduplicated object store. Files or directories may be comprised of multiple objects, and some files or directories may reference the same object as another file or directory. In particular, point-in-time backups of a same VM, for example, may reference many of the same objects in the object store. Backup and restoration may be space-efficient and time-efficient because at least some of the objects of a backed up or restored file or directory may already exist in the object store. Thus, backups of a VM may be iterated through and tested quickly (e.g., by instructions 350 and 370).

In alternate embodiments, the automated detection functionality described herein can be applied to multiple VMs in a host operating environment in order to find all system that are infected or impacted. In some embodiments, all infected or impacted VMs could be recovered in parallel and the most recent non-infected backup copy for each VM separately so that each infected VM is restored to the most recent safe backup copy of the appropriate data.

Thus, in various embodiments, the techniques described herein can work with any virtual machine and underlying hypervisor, and does not require any virus software or specialized agents running within the guest VM. Thus, the mechanism does not require any updated software or detection data from a hardware or software provider. The recovery techniques can be used in dark sites, and can be used to recover from one-off attacks or custom hacks. Further, the recovery techniques described can be used to identify a set of impacted systems/VMs automatically.

In generally, the hyper-converged environment can provide global resource pools across a cluster of devices and can provide real-time (or near real-time) deduplication, compression and optimization for data. Thus, a bandwidth-efficient replication and backup environment can be provided to ensure a high level of data integrity and availability, and can eliminate the need for additional/external backup solutions.

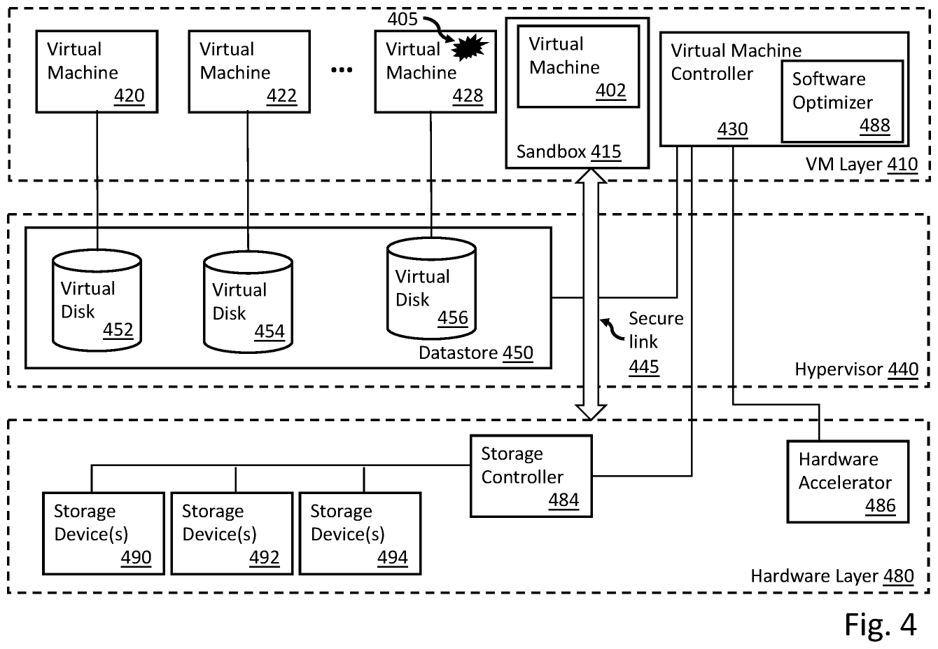

FIG. 4 is a block diagram of one embodiment of a hyper-converged architecture that can provide automated anomaly recovery in an environment having multiple virtual machines. The example architecture in FIG. 4 is one of many types of complex architectures that can provide automated anomaly recovery. The example of FIG. 4 can be a single node in a multi-node system. For example, the node of FIG. 4 can be a primary node, and a mirror node (not illustrated in FIG. 4) can function as a backup or secondary node. Larger computing environments with multiple independent nodes (with or without corresponding mirror nodes) can also be supported.

Hardware layer 480 provides the hardware processing and data storage devices to support multiple virtual machines and virtual computing environments. Hardware layer 480 can include, for example, hardware accelerator 486, storage controller 484 and multiple storage devices (490, 492, 494) coupled with storage controller 484. In one embodiment, storage controller 484 is a disk controller and storage devices 490, 492 and 494 are solid-state drive (SSD) devices. Other hardware devices can be included in hardware layer 480.

Virtual machine (VM) layer 410 provides any number of virtual machines (e.g., 420, 422, 428) with one or more virtual machine controller 430. In some embodiments, VM controller 430 includes software optimizer 488 that can provide some or all of deduplication, compression and/or optimization of data. In alternate embodiments, other virtual machine controllers can also be utilized.

Hypervisor 440 functions as an interface between the hardware components of hardware layer 480 and the virtual machines of VM layer 410. Hypervisor 440 can include, for example, data store 450 that can provide virtual disks (e.g., 452, 454, 456) for the virtual machines of VM layer 410. Datastore 450 can be, for example, a Network File System (NFS) datastore.

In some embodiments, storage controller 484 can be a redundant array of independent disks (RAID) controller and storage devices 490, 492, 494 can be a RAID array. Other storage configurations can also be supported. In some embodiments, hardware accelerator 486 can function to deduplicate, compress and/or optimize data as it is received by hardware layer 480.

In various embodiments hardware accelerator 486 or software optimizer 488 may be optional. That is, the architecture of FIG. 4 can include hardware accelerator 486 only (i.e., no software optimizer 488), or software optimizer 488 only (i.e., no hardware accelerator 486, or both hardware accelerator 486 and software optimizer 488.

During normal operation, the virtual machines operate in VM layer 410 and point-in-time backup copies of data are made based on parameters and policies for managing data backups. The data backup parameters and policies can be different for each VM. In one embodiment, backups can be stored on one or more of the virtual disks in datastore 450. This can result in the backup copies being stored on one or more of the storage devices in hardware layer 480.

When data (including, for example, backup data) is written by a virtual machine (e.g., 428), hypervisor 440 writes the data to datastore 450 (for example, to virtual disk 456). In some embodiments, when data is written to hardware layer 480, hardware accelerator 486 can analyze the data to be written to determine whether the data is unique. In some embodiments, if the data to be written is unique, the data is compressed and written to one or more storage devices in hardware layer 480. If the data to be written is not unique (i.e., it is duplicate data), the relevant metadata can be updated and a write to one or more of the storage devices in hardware layer 480 can be avoided.

This process of deduplication and compression can reduce input/output (I/0) operations and increase system performance. However, identifying the appropriate backup data in the event of an anomaly can be more complex than in a simplified environment. Thus, by the time an anomaly is detected (e.g., 405 in virtual machine 428), backup data for virtual machine 428 can be spread over multiple storage devices, may be split and or compressed.

In the example of FIG. 4, when an anomaly is detected (e.g., 405 in VM 428), virtual machine controller 430 can configure sandbox 415 to provide a secure, isolated operating environment for virtual machine 402, which is a point-in-time copy of virtual machine 428. Backup data can be obtained from hardware layer 480 via secure, isolated connection 445. As discussed above, the most recent point-in-time backup copy from virtual machine 428 can be restored to virtual machine 402 to start the automated recovery process.

After having the backup data restored, virtual machine 402 can be analyzed for an anomaly. If an anomaly is detected, the next oldest backup data can be obtained from hardware layer 480 and restored to virtual machine 402, which can be analyzed for an anomaly again with the subsequent backup data. Thus, the recovery process can be an automated iterative process. In some embodiments, the process proceeds in reverse chronological order.

In some embodiments, virtual machine 402, sandbox 415 and secure link 445 are created in response to detection of anomaly 405. When the recovery process is complete, one or more of virtual machine 402, sandbox 415 and secure link 445 can be destroyed and the corresponding resources freed for other uses.

In other embodiments, different restoration patterns can be used. For example, backup data from a previous day can be used first. If no anomaly is detected, more recent backups can be used until the most recent non-infected backup is located. When the most recent non-infected backup is determined, that backup can be utilized to restore the parent (originally infected virtual machine, e.g., 428). By utilizing the techniques and architectures described herein, a more efficient and transparent recovery process can be provided.

The example of FIG. 4 illustrates only a single secure environment and corresponding virtual machine are utilized for the recovery process. In other embodiments, any number of secure environments and virtual machines can be utilized to provide parallelism in the recovery process.

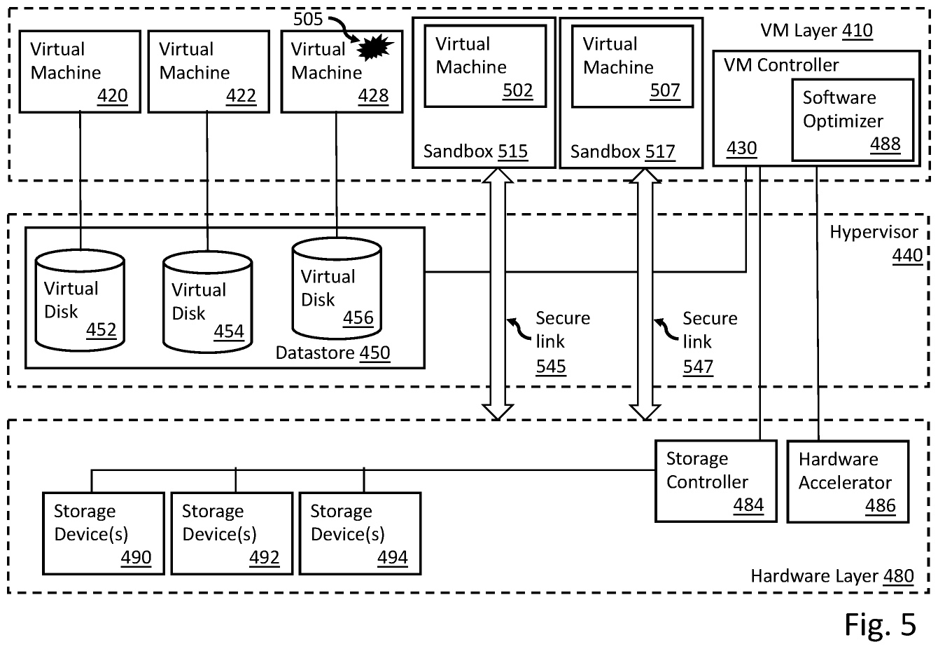

FIG. 5 is a block diagram of one embodiment of a hyper-converged architecture that can provide parallel automated anomaly recovery in an environment having multiple virtual machines. The parallel example of FIG. 5 illustrates only two parallel sandboxes, any number of parallel sandboxes and recovery operations can be provided.

Hypervisor 440 (including, for example, datastore 450, virtual disk 452, virtual disk 454 and virtual disk 456) and hardware layer 480 (including, for example, hardware accelerator 486, storage controller 484, storage device 490, storage device 492 and storage device 494) function as described above.

VM layer 410 provides any number of virtual machines (e.g., 420, 422, 428) with one or more virtual machine controller 430. During normal operation, the virtual machines operate in VM layer 410 and backup copies of data are made based on parameters and policies for managing data backups. The data backup parameters and policies can be different for each VM. In one embodiment, backups can be stored on one or more of the virtual disks in datastore 450. As discussed above, deduplication and/or other optimization functionality can be provided with software optimizer 488 and/or hardware accelerator 486. This can result in the backup copies being stored on one or more of the storage devices in hardware layer 480.

In various embodiments hardware accelerator 486 or software optimizer 488 may be optional. That is, the architecture of FIG. 5 can include hardware accelerator 486 only (i.e., no software optimizer 488), or software optimizer 488 only (i.e., no hardware accelerator 486, or both hardware accelerator 486 and software optimizer 488.

In the example of FIG. 5, when an anomaly is detected (e.g., 505 in VM 428), virtual machine controller 430 can configure sandbox 515 to provide a secure, isolated operating environment for virtual machine 502, which is a point-in-time copy of virtual machine 528. In the one embodiment, to provide parallel restoration functionality, virtual machine controller 430 can also configure sandbox 517 to provide a second secure, isolated operating environment for virtual machine 507, which is also a point-in-time copy of virtual machine 528.

Backup data can be obtained from hardware layer 480 via secure, isolated connections 545 and 547. In one embodiment, the most recent point-in-time backup copy from virtual machine 428 can be restored to virtual machine 502 to start the automated recovery process and the second most recent backup copy from virtual machine 428 can be restored to virtual machine 507.

After having the backup data restored, virtual machine 502 can be analyzed for an anomaly. If an anomaly is detected, the next oldest backup (e.g., third most recent backup) data can be obtained from hardware layer 480 and restored to virtual machine 502, which can be analyzed for an anomaly again with the subsequent backup data. Thus, the recovery process can be an automated iterative process. This iterative process can be performed in parallel using virtual machines 502 and 507 in sandboxes 515 and 517, respectively. In some embodiments, the process proceeds in reverse chronological order. In alternate embodiments, other strategies can be employed, for example, binary search or other non-sequential strategy. When the recovery process is complete, one or more of virtual machine 502, sandbox 515, secure link 545 virtual machine 507, sandbox 517 and secure link 547 can be destroyed and the corresponding resources freed for other uses.

As discussed above, different restoration patterns can also be supported. Further, the example of FIG. 5 illustrates only two secure environments and corresponding virtual machines that are utilized for the recovery process. In other embodiments, any number of secure environments and virtual machines can be utilized to provide additional parallelism in the recovery process.

The terminology used herein is for the purpose of describing particular examples and is not intended to be limiting. As used herein, the singular forms “a,” “an,” and “the” are intended to include the plural forms as well, unless the context clearly indicates otherwise. The term “another,” as used herein, is defined as at least a second or more. The term “coupled,” as used herein, is defined as connected, whether directly without any intervening elements or indirectly with at least one intervening element, unless indicated otherwise. For example, two elements can be coupled mechanically, electrically, or communicatively linked through a communication channel, pathway, network, or system.

The term “and/or” as used herein refers to and encompasses any and all possible combinations of the associated listed items. It will also be understood that, although the terms first, second, third, fourth, etc. may be used herein to describe various elements, these elements should not be limited by these terms, as these terms are only used to distinguish one element from another unless stated otherwise or the context indicates otherwise. As used herein, the term “includes” means includes but not limited to, the term “including” means including but not limited to. The term “based on” means based at least in part on.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
generating a virtual machine copy having an isolated network connection in response to an anomaly condition in an original virtual machine, wherein the virtual machine copy is a copy of a parent virtual machine;
iteratively restoring backup data to the virtual machine copy utilizing the isolated network connection to generate a restored virtual machine;
causing the restored virtual machine to be evaluated for the anomaly condition; and
replacing the original virtual machine with the restored virtual machine if the anomaly condition does not exist in the restored virtual machine.

2. The method of claim 1 wherein the isolated network comprises a virtual private network (VPN) and the virtual machine copy operates in a sandbox environment.

3. The method of claim 1, wherein multiple virtual machine copies are generated and multiple backup copies are applied to the multiple virtual machine copies in parallel.

4. The method of claim 1 wherein the anomaly comprises a ransomware attack.

5. The method of claim 1 wherein the anomaly comprises an electronic virus attack.

6. The method of claim 1 wherein causing the restored virtual machine to be evaluated for the anomaly condition comprises triggering an anomaly detection mechanism.

7. The method of claim 1 wherein causing the restored virtual machine to be evaluated for the anomaly condition comprises:
installing an anomaly detection mechanism in restored virtual machine; and
causing the installed anomaly detection mechanism to evaluate the restored virtual machine.

8. A non-transitory computer-readable medium having stored thereon sequences of instructions that, when executed by one or more processors, are configurable to cause the one or more processors to:
generate a virtual machine copy having an isolated network connection in response to an anomaly condition in an original virtual machine, wherein the virtual machine copy is a copy of a parent virtual machine;
restore a first backup to the virtual machine copy utilizing the isolated network connection to generate a first restored virtual machine;
cause the first restored virtual machine to be evaluated for the anomaly condition;
replace the original virtual machine with the first restored virtual machine if the anomaly condition does not exist in the first restored virtual machine; and
restore a second backup copy to the virtual machine copy utilizing the isolated network connection to generate a second restored virtual machine if the anomaly condition exists in the first restored virtual machine.

9. The non-transitory computer-readable medium of claim 8 further comprising instructions that, when executed by the one or more processors, are configurable to cause the one or more processors to:
cause the second restored virtual machine to be evaluated for the anomaly condition;
replace the original virtual machine with the second restored virtual machine if the anomaly condition does not exist in the second restored virtual machine;
restore a third backup copy to the virtual machine copy utilizing the isolated network connection to generate a third restored virtual machine if the anomaly condition exists in the first restored virtual machine.

10. The non-transitory computer-readable medium of claim 8 wherein the isolated network comprises a virtual private network (VPN) and the virtual machine copy operates in a sandbox environment.

11. The non-transitory computer-readable medium of claim 8, wherein multiple virtual machine copies are generated and multiple backup copies are applied to the multiple virtual machine copies in parallel.

12. The non-transitory computer-readable medium of claim 8 wherein the anomaly comprises a ransomware attack.

13. The non-transitory computer-readable medium of claim 8 wherein the anomaly comprises an electronic virus attack.

14. The non-transitory computer-readable medium of claim 8 wherein causing the first restored virtual machine to be evaluated for the anomaly condition comprises triggering an anomaly detection mechanism.

15. A system comprising:
a memory system; and
one or more hardware processors coupled with the memory system, the one or more hardware processors configured to generate a virtual machine copy having an isolated network connection in response to an anomaly condition in an original virtual machine, wherein the virtual machine copy is a copy of a parent virtual machine, to restore a first backup to the virtual machine copy utilizing the isolated network connection to generate a first restored virtual machine, to cause the first restored virtual machine to be evaluated for the anomaly condition, to replace the original virtual machine with the first restored virtual machine if the anomaly condition does not exist in the first restored virtual machine, and to restore a second backup copy to the virtual machine copy utilizing the isolated network connection to generate a second restored virtual machine if the anomaly condition exists in the first restored virtual machine.

16. The system of claim 15 wherein the one or more hardware processors are further configured to cause the second restored virtual machine to be evaluated for the anomaly condition, to replace the original virtual machine with the second restored virtual machine if the anomaly condition does not exist in the second restored virtual machine, and to restore a third backup copy to the virtual machine copy utilizing the isolated network connection to generate a third restored virtual machine if the anomaly condition exists in the first restored virtual machine.

17. The system of claim 15 wherein the isolated network comprises a virtual private network (VPN) and the virtual machine copy operates in a sandbox environment.

18. The system of claim 15, wherein multiple virtual machine copies are generated and multiple backup copies are applied to the multiple virtual machine copies in parallel.

19. The system of claim 15 wherein the anomaly comprises a ransomware attack.

20. The system of claim 15 wherein the anomaly comprises an electronic virus attack.
